(19) United States
(12) Patent Application Publication
(10) Pub. No.: US 2005/0148262 A1
(43) Pub. Date: Jul. 7, 2005

(54) Wet wipe with low liquid add-on

(76) Inventors: Eugenio Go Varona, Marietta, GA (US); Angelina Lapid Varona, Marietta, GA (US); Alan Edward Wright, Woodstock, GA (US); Timothy Walter Shoaf, Appleton, WI (US)

Correspondence Address: KIMBERLY-CLARK WORLDWIDE, INC., 401 NORTH LAKE STREET, NEENAH, WI, 54956, US

(21) Appl. No.: 10/748,614

(22) Filed: Dec. 30, 2003

(51) Int. Cl. D04H 1/00; D04H 3/00; B32B 21/10; B32B 5/26; B32B 27/12

(52) U.S. Cl. 442/381; 442/327; 442/385; 442/389; 442/394

(57) ABSTRACT

The present invention provides a wet wipe prepared from at least a two layer laminate material. In addition to the laminate, the wet wipe also contains a cleaning fluid. As for the laminate, the laminate has a first layer which contains a web material capable of holding and releasing the cleaning fluid and a second layer, adjacent the first layer, which has, by virtue of its structure and/or composition, less affinity for the cleaning solution than the first layer. The first layer contains a larger percentage of the cleaning fluid than the second layer. Also disclosed is a three layer laminate containing wipe wherein the intermediate layer has less affinity for the cleaning solution than the outer layers.

### FIELD OF THE INVENTION

The present invention relates to a wet wipe.

### BACKGROUND OF THE INVENTION

Nonwoven fabrics or webs are useful for a wide variety of applications such as diapers, feminine hygiene products, towels, wipers, recreational or protective fabrics and as geotextiles and filter media. The nonwoven webs used in these applications may be simply spunbond fabrics, but are often in the form of nonwoven fabric laminates like spunbond/spunbond laminates or spunbond/meltblown/spunbond (SMS) laminates. Laminates with other materials are also possible, such as with films and paper.

Saturated or pre-moistened paper and textile wipers have been used in a variety of wiping and polishing cloths. These substrates are often provided in a sealed container and retrieved therefrom in a moist or saturated condition (i.e. pre-moistened). The pre-moistened cloth or paper wiper releases the retained liquid when used to clean or polish the desired surface. In addition, meltblown fiber fabrics have also been used as pre-moistened wipers in various applications and end uses. It is known that meltblown fiber fabrics are capable of receiving and retaining liquids for extended periods of time. More particularly, meltblown fiber fabrics are capable of being supplied in a stacked or rolled form wherein, when saturated with a liquid, the meltblown fiber fabrics maintain the liquid uniformly distributed throughout the stack. Thus, meltblown fiber sheets can be stacked in a sealable container and liquid added thereto. The sealed container can then be stored or shipped as needed and the stacked meltblown fabric retains the liquid evenly throughout the stack during the shelf life of the product. Uniformly moist meltblown fiber fabrics provided in a stacked form are described in U.S. Pat. Nos. 4,853,281 and 4,833,033, both to Win et al. Pre-moistened meltblown fiber fabrics have found a wide variety of applications including use as polishing clothes, hand wipes, hard surface cleaners and so forth. By way of example, various applications of pre-saturated meltblown fabrics are described in U.S. Pat. No. 5,656,361 to Vogt et al. U.S. Pat. No. 5,595,786 to McBride et al. and U.S. Pat. No. 5,683,971 to Rose et al.

The nonwoven materials and laminated nonwoven materials that are useful for consumer products should meet minimum product standards for strength, moisture level, size, flexibility, thickness, softness and texture. Often it is desirable to change one of these parameters to meet a specific need, such as improved product performance or cost savings. However, if one of these parameters is changed this can adversely affect one or more of the other parameters. Thus, a goal when changing one of these parameters is to minimize the adverse impact on the other parameters.

A significant portion of overall weight of a wet wipe comes from the liquid which wets the wet wipe. During use most of the cleaning fluid of the wet wipe goes unused and is wasted when the wipe is disposed of following use. Significant cost savings may be realized, in the areas of raw material cost and shipping cost, by reducing the amount of the cleaning fluid in a wet wipe. However, reducing the amount of cleaning fluid must not adversely affect the user's perception of the wet wipe, i.e. the wipe should not be perceived as too dry to accomplish the desired cleaning. When used as a wet wipe, it is also important that the wipe material has an overall moist feeling to the user. The user's perception of moisture is related to the weight percent of cleaning fluid present in the wipe. This weight percent is referred to as “add-on” and for a given nonwoven material there is typically an optimal add-on that balances product performance and cost factors. One method of reducing the cleaning fluid add-on is to reduce the overall basis weight of the nonwoven material used to produce the wipe. However, basis weight influences other consumer-important product performance parameters such as thickness, softness, durability and strength. Therefore, reducing the basis weight is not a viable means for reducing the cleaning fluid add-on.

### SUMMARY OF THE INVENTION

The present invention provides a wet wipe prepared from at least a two layer laminate material. In addition to the laminate, the wet wipe also contains a cleaning fluid. As for the laminate, the laminate has a first layer which contains a web material capable of holding and releasing the cleaning fluid arid a second layer, adjacent the first layer, which has, by virtue of its structure and/or composition, less affinity for the cleaning solution than the first layer. Stated another way, a first layer has a thickness X; and the second layer has a thickness Y. However, the percentage of the overall cleaning fluid in the wipe present in the second layer is less than the percentage of the thickness attributed to the wipe from the second layer. Stated in a mathematical equation, the second layer has an overall percentage of the cleaning fluid present in the wipe Z;
wherein

$$Z \leq \frac{Y}{( X + Y )} \times 100 \% .$$

For example, if the second layer is 75% of the thickness of the wipe and the first layer is 25% of the thickness of the wipe, then the percentage of the cleaning fluid in the second layer is less than 75%. It is noted that the percentages are either weight or volume percentages. In a similar manner if the second layer is 25% of the thickness of the wipe and the first layer is 75% of the thickness of the wipe, then the percentage of the cleaning fluid in the second layer is less than 25%.

The laminate used in the wet wipe of the present invention may have a third layer present. This third layer is adjacent to the second layer and on a side of the second layer opposite the side adjacent to the first layer. The third layer, like the first, contains a web capable of holding and releasing the cleaning fluid. The third layer has a thickness X′. When the third layer is present in the laminate, then the percentage Z of the overall cleaning fluid present in the second layer of the wipe is

$$Z \leq \frac{Y}{( X + {X}^{′} + Y )} \times 100 \% .$$

In there practice of the present invention, the first and/or third layers may be prepared from a woven material, a knitted material or nonwoven material including conform nonwoven webs, meltblown nonwoven webs, airlaid nonwoven web, or hydroentangled nonwoven webs. The second layer or intermediate layer may be a foam, an apertured film, a textured film or a hydrophobic nonwoven web.

In an aspect of the present invention, the second or intermediate layer makes up (at least) approximately 35% of the bulk of the wipe of the present invention, desirably at least 50% of the bulk of the wipe. In addition, the second or intermediate layer holds less than about 40% by weight of the cleaning fluid, when the second or intermediate layer makes up at least 50% of the bulk of the wipe.

### BRIEF DESCRIPTION OF THE DRAWINGS

FIG. 1 shows a two-layer laminate used as the base sheet in the wet wipe of the present invention.

FIG. 2 shows a three-layer laminate used as the base sheet in the wet wipe of the present invention.

FIG. 3 shows a three-layer laminate used as the base sheet in the wet wipe of the present invention, with an apertured second or intermediate layer.

### DEFINITIONS

As used herein, the term “comprising” is inclusive or open-ended and does not exclude additional unrecited elements, compositional components, or method steps.

As used herein, the term “consisting essentially of” does not exclude the presence of additional materials which do not significantly affect the desired characteristics of a given composition or product. Exemplary materials of this sort would include, without limitation, pigments, antioxidants, stabilizers, surfactants, waxes, flow promoters, particulates and materials added to enhance processability of the composition.

As used herein, the term “fiber” includes both staple fibers, i.e., fibers which have a defined length between about 1 mm and about 60 mm, fibers longer than staple fiber but are not continuous, and continuous fibers, which are sometimes called “substantially continuous filaments” or simply “filaments”. The method in which the fiber is prepared will determine if the fiber is a staple fiber or a continuous filament.

As used herein, the term “microfibers” means small diameter fibers having an average diameter not greater than about 40 microns, for example, having an average diameter of from about 0.5 microns to about 40 microns, or more particularly, microfibers may have an average diameter of from about 4 microns to about 40 microns.

As used herein, the term “macrofibers” means large diameter fibers having an average diameter generally greater than about 40 microns, for example, having an average diameter of from about 40 microns to about 100 microns.

As used herein, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “nonwoven web” means a web having a structure of individual fibers or threads which are interlaid, but not in an organized manner as in a knitted web. Nonwoven webs have been formed from many processes, such as, for example, meltblowing processes, spunbonding processes, air-laying processes, coforming processes and bonded carded web processes. The basis weight of nonwoven webs is usually expressed in ounces of material per square yard (osy) or grams per square meter (gsm) and the fiber diameters are usually expressed in microns, or in the case of staple fibers, denier. It is noted that to convert from osy to gsm, multiply osy by 33.91.

“Meltblown” refers to fibers formed by extruding a molten thermoplastic material through a plurality of fine, usually circular, die capillaries as molten threads or filaments into converging high velocity heated gas (e.g., air) streams which attenuate the filaments of molten thermoplastic material to reduce their diameters. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al. Meltblowing processes can be used to make fibers of various dimensions, including macrofibers (with average diameters from about 40 to about 100 microns), textile-type fibers (with average diameters between about 10 and about 40 microns), and microfibers (with average diameters less than about 10 microns). Meltblowing processes are particularly suited to making microfibers, including ultra-fine microfibers (with average diameters of about 3 microns or less). Meltblown fibers may be continuous or discontinuous, and are generally self bonding when deposited onto a collecting surface. Meltblown fibers used in the present invention are preferably substantially continuous in length. A description of an exemplary process of making ultra-fine microfibers may be found in, for example, U.S. Pat. No. 5,213,881, entitled “A Nonwoven Web With Improved Barrier Properties”.

As used herein the term “spunbond fibers” refers to small diameter fibers of molecularly oriented polymeric material. Spunbond fibers may be formed by extruding molten thermoplastic material as filaments from a plurality of fine, usually circular capillaries of a spinneret with the diameter of the extruded filaments then being rapidly reduced as in, for example, U.S. Pat. No.4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,542,615 to Dobo et al, and U.S. Pat. No. 5,382,400 to Pike et al. Spunbond fibers are generally not tacky when they are deposited onto a collecting surface and are generally continuous. Spunbond fibers are often about 10 microns or greater in diameter. However, fine fiber spunbond webs (having an average fiber diameter less than about 10 microns) may be achieved by various methods including, but not limited to, those described in commonly assigned U.S. Pat. No. 6,200,669 to Marmon et al. and U.S. Pat. No. 5,759,926 to Pike et al., each is hereby incorporated by reference in its entirety.

“Airlaying” or “airlaid” is a well known process by which a fibrous nonwoven layer can be formed. In the airlaying process, bundles of small fibers having typical lengths ranging from about 3 to about 19 millimeters (mm) are separated and entrained in an air supply and then deposited onto a forming screen, usually with the assistance of a vacuum supply. The randomly deposited fibers then are bonded to one another using, for example, hot air or a spray adhesive.

As used herein, the term “conform nonwoven web” or “conform material” means composite materials comprising a mixture or stabilized matrix of thermoplastic filaments and at least one additional material, usually called the “second material” or the “secondary material”. As an example, conform materials may be made by a process in which at least one meltblown die head is arranged near a chute through which the second material is added to the web while it is forming. The second material may be, for example, an absorbent material such as fibrous organic materials such as woody and non-wood cellulosic fibers, including regenerated fibers such as cotton, rayon, recycled paper, pulp fluff; superabsorbent materials such as superabsorbent particles and fibers; inorganic absorbent materials and treated polymeric staple fibers and the like; or a non-absorbent material, such as non-absorbent staple fibers or non-absorbent particles. Exemplary conform materials are disclosed in commonly assigned U.S. Pat. No. 5,350,624 to Georger et al.; U.S. Pat. No. 4,100,324 to Anderson et al.; and U.S. Pat. No. 4,818,464 to Lau et al.; the entire contents of each is hereby incorporated by reference.

“Bonded carded web” refers to webs that are made from staple fibers which are sent through a combing or carding unit, which separates or breaks apart and aligns the staple fibers in the machine direction to form a generally machine direction-oriented fibrous nonwoven web. Such fibers are usually purchased in bales which are placed in an opener/blender or picker which separates the fibers prior to the carding unit. Once the web is formed, it then is bonded by one or more of several known bonding methods. One such bonding method is powder bonding, wherein a powdered adhesive is distributed through the web and then activated, usually by heating the web and adhesive with hot air. Another suitable bonding method is pattern bonding, wherein heated calender rolls or ultrasonic bonding equipment are used to bond the fibers together, usually in a localized bond pattern, though the web can be bonded across its entire surface if so desired. Another suitable and well-known bonding method, particularly when using bicomponent staple fibers, is through-air bonding.

As used herein, the term “multicomponent fibers” refers to fibers or filaments which have been formed from at least two polymers extruded from separate extruders but spun together to form one fiber. Multicomponent fibers are also sometimes referred to as “conjugate” or “bicomponent” fibers or filaments. The term “bicomponent” means that there are two polymeric components making up the fibers. The polymers are usually different from each other, although conjugate fibers may be prepared from the same polymer, if the polymer in each component is different from one another in some physical property, such as, for example, melting point or the softening point. In all cases, the polymers are arranged in substantially constantly positioned distinct zones across the cross-section of the multicomponent fibers or filaments and extend continuously along the length of the multicomponent fibers or filaments. The configuration of such a multicomponent fiber may be, for example, a sheath/core arrangement, wherein one polymer is surrounded by another, a side-by-side arrangement, a pie arrangement or an “islands-in-the-sea” arrangement. Multicomponent fibers are taught in U.S. Pat. No. 5,108,820 to Kaneko et al.; U.S. Pat. No. 5,336,552 to Strack et al.; and U.S. Pat. No. 5,382,400 to Pike et al.; the entire content of each is incorporated herein by reference. For two component fibers or filaments, the polymers may be present in ratios of 75/25, 50/50, 25/75 or any other desired ratios.

As used herein, the term “multiconstituent fibers” refers to fibers which have been formed from at least two polymers extruded from the same extruder as a blend or mixture. Multiconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random. Fibers of this general type are discussed in, for example, U.S. Pat. Nos. 5,108,827 and 5,294,482 to Gessner.

As used herein, the term “pattern bonded” refers to a process of bonding a nonwoven web in a pattern by the application of heat and pressure or other methods, such as ultrasonic bonding. Thermal pattern bonding typically is carried out at a temperature in a range of from about 80° C. to about 180° C. and a pressure in a range of from about 150 to about 1,000 pounds per linear inch (59-178 kg/cm). The pattern employed typically will have from about 10 to about 250 bonds/inch² (1-40 bonds/cm²) covering from about 5 to about 30 percent of the surface area. Such pattern bonding is accomplished in accordance with known procedures. See, for example, U.S. Design Pat. No. 239,566 to Vogt, U.S. Design Pat. No. 264,512 to Rogers, U.S. Pat. No. 3,855,046 to Hansen et al., and U.S. Pat. No. 4,493,868 to Meitner et al. and U.S. Pat. No. 5,858,515 to Stokes et al., for illustrations of bonding patterns and a discussion of bonding procedures, which patents are incorporated herein by reference. Ultrasonic bonding is performed, for example, by passing the multilayer nonwoven web laminate between a sonic horn and anvil roll as illustrated in U.S. Pat. No. 4,374,888 to Bornslaeger, which is hereby incorporated by reference in its entirety.

As used herein, the term “wet wipe” refers to a fibrous sheet which, during its manufacture, has a liquid applied thereto so that the liquid can be retained on or within the fibrous sheet until its utilization by a consumer. The liquid may include a fragrance and/or an emollient and may serve to aid the fibrous sheet in retention of materials which are to be wiped up during its utilization.

As used herein, the term “palindromic” means a multilayer laminate, for example a stretch-bonded laminate, which is substantially symmetrical. Examples of palindromic laminates could have layer configurations of ANB/A, ANB/B/A, ANANB/B/NAA, ANB/C/B/A, and the like. Examples of non-palindromic layer configurations would include A/B/C, ANB/C/A, A/B/C/D, etc.

As used herein, the term “essentially does not contain” means that the layer is essentially free of the component mentioned, in the case of the present application, the cleaning fluid. This does not mean that the layer is absolutely free of the cleaning fluid, but is intended to mean that the layer contains only a very small amount, such as less than 0.5% by weight of the cleaning fluid.

As used herein, the term “apertured film material” refers to a generally flat or planar layer of material which has been punched, drilled, apertured, stretched, perforated, embossed, patterned, crinkled and/or otherwise processed so that it may have relatively gross or visible openings with or without a pattern or texture in the thickness dimension (i.e., Z-direction) of the material. Exemplary apertured film materials include, but are not limited to, perforated-embossed films, textured apertured films, reticulated apertured films, contoured apertured films, and expanded plexi-filamentary films.

### DETAILED DESCRIPTION OF THE INVENTION

The present invention provides a wet wipe prepared from at least a two layer laminate material. In addition to the laminate, the wet wipe also contains a cleaning fluid. As for the laminate, the laminate has a first layer which contains a web material capable of holding and releasing the cleaning fluid and a second layer, adjacent the first layer, which has, by virtue of its structure and/or composition, less affinity for the cleaning solution than the first layer. Stated another way, a first layer has a thickness X; and the second layer has a thickness Y. However, the percentage of the overall cleaning fluid in the wipe present in the second layer is less than the percentage of the thickness attributed to the wipe from the second layer. Stated in a mathematical equation, the second layer has an overall percentage of the cleaning fluid present in the wipe Z;
wherein

$$Z \leq \frac{Y}{( X + Y )} \times 100 \% .$$

For example, if the second layer is 75% of the thickness of the wipe and the first layer is 25% of the thickness of the wipe, then the percentage of the cleaning fluid in the second layer of the wipe is less than 75%. It is noted that the percentages are either weight or volume percentages. In a similar manner if the second layer is 25% of the thickness of the wipe and the first layer is 75% of the thickness of the wipe, then the percentage of the cleaning fluid in the second layer of the wipe is less than 25%.

The material caliper (thickness or bulk) is a measure of thickness and is measured at 0.05 psi with a Starret-type bulk tester, in units of millimeters. The individual layers can be measured prior to assembly or in an assembled wipe the layers can be carefully pulled apart to be measured.

The laminate used in the wet wipe of the present invention may have a third layer present. This third layer is adjacent to the second layer and on a side of the second layer opposite the side adjacent to the first layer. The third layer, like the first, contains a web capable of holding and releasing the cleaning fluid. The third layer has a thickness X′. When the third layer is present in the laminate, then the percentage Z of the overall cleaning fluid present in the second layer of the wipe is

$$Z \leq \frac{Y}{( X + {X}^{′} + Y )} \times 100 \% .$$

The second layer or intermediate layer may be a foam, an apertured film, a textured film or a hydrophobic nonwoven web.

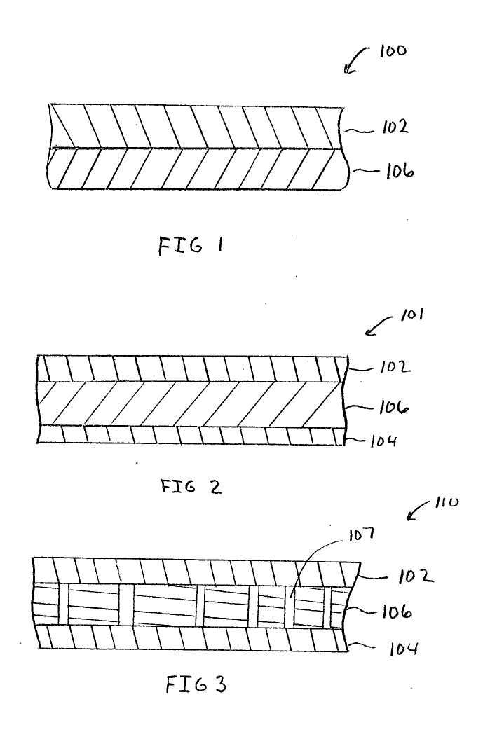

In order to obtain a better understanding of the present invention, attention is directed to FIG. 1. In FIG. 1, a laminate 100, is shown having two layers 102, and 106. Figure numeral 102 is the first layer and figure numeral 106 is the second layer. FIG. 2 shows a three layer laminate 101. Figure numeral 102 is the first layer and figure numeral 104 is the third layer. Positioned between the first and third layers is a second or intermediate layer 106.

The first and third outer layers may be prepared from a woven material, a knitted material or a nonwoven web including conform nonwoven webs, meltblown nonwoven webs, airlaid nonwoven web, bonded carded webs, cellulosic fiber webs or hydroentangled nonwoven webs. Generally, it is preferred, but not required that the fibers of these nonwoven webs are prepared from thermoplastic polymers. Further, generally, it is preferred, but not required that a conform nonwoven web be used as the first and second layers.

In conform nonwoven webs a coherent integrated fibrous structure can be formed by the thermoplastic microfibers and wood pulp fibers without any adhesive, molecular or hydrogen bonds between the two different types of fibers. The absorbent fibers are preferably distributed uniformly throughout the matrix of thermoplastic microfibers to provide a homogeneous material. The material is formed by initially forming a primary air stream containing the melt blown microfibers, forming a secondary air stream containing the wood pulp fibers, merging the primary and secondary streams under turbulent conditions to form an integrated air stream containing a thorough mixture of the microfibers and wood pulp fibers, and then directing the integrated air stream onto a forming surface to air form the fabric-like material. The microfibers are in a soft nascent condition at an elevated temperature when they are turbulently mixed with the wood pulp fibers in air.

Suitable thermoplastic polymers useful for preparing the fibers or filaments of the individual nonwoven layers of the laminate of the present invention include polyolefins, polyesters, polyamides, polycarbonates, polyurethanes, polyvinylchloride, polytetrafluoroethylene, polystyrene, polyethylene terephathalate, biodegradable polymers such as polylactic acid and copolymers and blends thereof. Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene, and blends thereof; polybutylene, e.g., poly(1-butene) and poly(2-butene); polypentene, e.g., poly(1-pentene) and poly(2-pentene); poly(3-methyl-1-pentene); poly(4-methyl1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include polyethylene terephthalate, polytrimethylene terephthalate, polybutylene terephthalate, polytetramethylene terephthalate, polycyclohexylene-1,4-dimethylene terephthalate, and isophthalate copolymers thereof, as well as blends thereof.

Many polyolefins are available for fiber production, for example polyethylenes such as Dow Chemical's ASPUN 6811A linear low-density polyethylene, 2553 LLDPE and 25355 and 12350 high density polyethylene are such suitable polymers. The polyethylenes have melt flow rates in g/10 min. at 190° F. and a load of 2.16 kg, of about 26, 105, 25 and 12, respectively. Fiber forming polypropylenes include, for example, Basell's PF-015 polypropylene. Many other polyolefins are commercially available and generally can be used in the present invention. The particularly preferred polyolefins are polypropylene and polyethylene.

Examples of polyamides and their methods of synthesis may be found in “Polyamide Resins” by Don E. Floyd (Library of Congress Catalog number 66-20811, Reinhold Publishing, N.Y., 1966). Particularly commercially useful polyamides are nylon 6, nylon-6,6, nylon-11 and nylon-1 2. These polyamides are available from a number of sources such as Custom Resins, Nyltech, among others. In addition, a compatible tackifying resin may be added to the extrudable compositions described above to provide tackified materials that autogenously bond or which require heat for bonding. Any tackifier resin can be used which is compatible with the polymers and can withstand the high processing (e.g., extrusion) temperatures. If the polymer is blended with processing aids such as, for example, polyolefins or extending oils, the tackifier resin should also be compatible with those processing aids. Generally, hydrogenated hydrocarbon resins are preferred tackifying resins, because of their better temperature stability. REGALREZ® and ARKON®P series tackifiers are examples of hydrogenated hydrocarbon resins. ZONATAC®501 Lite is an example of a terpene hydrocarbon. REGALREZ®hydrocarbon resins are available from Hercules Incorporated. ARKON®P series resins are available from Arakawa Chemical (USA) Incorporated. The tackifying resins such as disclosed in U.S. Pat. No. 4,787,699, hereby incorporated by reference, are suitable. Other tackifying resins that are compatible with the other components of the composition and can withstand the high processing temperatures may also be used.

Of these thermoplastic polymers, polyolefins are desirably used. In particular polyethylene and polypropylene are most desirable. The fibers used in each of the layer of the present invention may be monocomponent fibers, multicomponent fibers, multiconstituent fibers. In addition, the fibers may be shaped, or round fibers.

The conform nonwoven web layer(s) can have from 20-60 wt. % of thermoplastic polymer fibers and 80-40 wt. % of pulp fibers. The desired ratio of polymer fibers to pulp fibers can be from 25-40 wt. % of polymer fibers and 75-60 wt. % of pulp fibers. A more desired ratio of polymer fibers to pulp fibers can be from 30-40 wt. % of polymer fibers and 70-60 wt. % of pulp fibers.

Fibers of diverse natural origin are applicable to the invention. Digested cellulose fibers from softwood (derived from coniferous trees), hardwood (derived from deciduous trees) or cotton linters can be utilized. Fibers from Esparto grass, bagasse, kemp, flax, and other lignaceous and cellulose fiber sources may also be utilized as raw material in the invention. For reasons of cost, ease of manufacture and disposability, preferred fibers are those derived from wood pulp (i.e., cellulose fibers). A commercial example of such a wood pulp material is available from Weyerhaeuser as CF-405. Generally wood pulps can be utilized. Applicable wood pulps include chemical pulps, such as Kraft (i.e., sulfate) and sulfite pulps, as well as mechanical pulps including, for example, groundwood, thermomechanical pulp (i.e., TMP) and chemithermomechanical pulp (i.e., CTMP). Completely bleached, partially bleached and unbleached fibers are useful herein. It may frequently be desired to utilize bleached pulp for its superior brightness and consumer appeal.

Also useful in the present invention are fibers derived from recycled paper, which can contain any or all of the above categories as well as other non-fibrous materials such as fillers and adhesives used to facilitate the original paper making process.

The second or intermediate layer of the present invention is prepared from a material which contributes significant thickness to the laminate but whose retention of cleaning fluid is disproportionately small compared to its contribution to thickness. Examples of this layer include foams, apertured films and bulky hydrophobic nonwoven webs. This third or intermediate layer desirably provides bulk to the laminate. Ideally, at least 35% of the thickness of the laminate comes from the intermediate layer. Generally, the intermediate layer makes up somewhere between 35 and 75% of the overall thickness of the laminate. More desirably, the intermediate layer provides at least 50% of the bulk or overall thickness of the laminate.

The foams usable in the second or intermediate layer include open and closed cell foams. If the foam is a closed cell foam, in order for the cleaning fluid to be able to migrate between the first and second layers, the closed cell foam would have to be provided with channels for the cleaning fluid to migrate. One method of providing channels would be to aperture the closed cell foam. If the foam is an open cell foam, the foam should be prepared from a hydrophobic material, or the cells should have a pore size radius such that the cleaning fluid is unable to be retained within the cell structure.

The apertured films usable in the present invention may be textured apertured films, embossed apertured films, reticulated apertured films, contoured apertured films or combinations thereof. The apertures should be of sufficient pore size radius that the apertured film does not hold large quantities of the cleaning fluid. FIG. 3 shows a three layer laminate 110 with the second layer 106 positioned between a first layer 102 and the third layer 104. The second layer 106 has apertures 107. Desirably, the apertured film is a textured apertured film. The apertured film-like material may be formed from a thermoplastic polymer. For example, the thermoplastic polymer may be selected from polyolefins, polyamides and polyesters. If the polymer is a polyolefin, it may be selected from polyethylene, polypropylene, polybutene, ethylene copolymers, propylene copolymers, and butene copolymers and blends of the same.

Another material suitable as the second or intermediate layer is hydrophobic nonwoven webs. Suitable nonwoven webs for the intermediate layer include, for example, lofty nonwoven webs, such as those described in U.S. Pat. 5,382,400, to Pike et al., which is hereby incorporated by reference in its entirety, are particularly usable in the present invention. The nonwoven webs describe by Pike et al. are nonwoven webs having crimped fibers or filaments. Other hydrophobic nonwoven webs can be used in this layer; however, of the nonwoven webs mentioned, spunbond and bonded carded web are desired from an economic and performance standpoint. The hydrophobic nonwoven web may also be creped. Creped nonwoven preferably have a creping level in the range of about 1 to about 60%. Ideally, the creping level is desirably about 30% to about 50%. Creped nonwovens useable in this invention include those described in U.S. Pat. No. 6,150,002 to Varona, which is hereby incorporated by reference in its entirety.

In order to make the nonwoven web to be hydrophobic, it is necessary that the fiber be prepared from hydrophobic materials. Suitable hydrophobic material include thermoplastic polymers, such as polyolefins. If the hydrophobic material is a polyolefin, it may be selected from polyethylene, polypropylene, polybutene, ethylene copolymers, propylene copolymers, and butene copolymers and blends of the same. Alternatively, more hydrophilic materials may be used, provided that the materials are rendered hydrophobic by applying a treatment to the fibers of the nonwoven web.

In a different embodiment of the present invention, a wet wipe is described which is prepared from at least a three layer laminate material and which contains a cleaning fluid. As for the laminate, the laminate has a first outer layer which contains a nonwoven web capable of holding and releasing the cleaning fluid and a third layer opposite the first outer layer which contains a nonwoven web capable of holding and releasing the cleaning fluid. Positioned between the first and third layers is a second or intermediate layer which contains a closed cell foam. In this embodiment, the closed cell foam is not apertured and typically holds little, if any, of the cleaning fluid. When a closed cell foam is used as the intermediate layer, the intermediate layer is occluded such that the cleaning fluid in the first layer is unable to migrate to the second layer and visa versa.

Additional advantages are realized by using the closed cell foam. In particular, the closed cell foam provides a barrier between the user of the wipe and the surface being cleaned. This can be advantageous when a user of a wipe is cleaning a surface which may pose a health threat to the user.

When a foam is utilized in the present invention, whether a closed or open cell foam with or without apertures, it may be advantageous to soften the foam to improve hand or drape of the foam and the overall laminate. This can be accomplished by methods known to those skilled in the art, such as adding a softening material to the foam precursor, for example, a plasticizer or, in addition mechanically softening the foam by using a process such as embossing, grooving, or creping.

The layers of the multilayer laminate may be generally bonded in some manner as they are produced in order to give them sufficient structural integrity to withstand the rigors of further processing into a finished product and during use as the finished product. Bonding can be accomplished in a number of ways such as hydroentanglement, needling, ultrasonic bonding, adhesive bonding and thermal bonding. Ultrasonic bonding is performed, for example, by passing the multilayer nonwoven web laminate between a sonic horn and anvil roll as illustrated in U.S. Pat. No. 4,374,888 to Bornslaeger, which is hereby incorporated by reference in its entirety.

Thermal bonding of a multilayer laminate may be accomplished by passing the laminate between the rolls of a calendering machine. At least one of the rollers of the calender is heated and at least one of the rollers, not necessarily the same one as the heated one, has a pattern which is imprinted upon the laminate as it passes between the rollers. As the laminate passes between the rollers, the laminate is subjected to pressure as well as heat. The combination of heat and pressure applied in a particular pattern results in the creation of fused bond areas in the multilayer laminate where the bonds thereon correspond to the pattern of bond points on the calender roll.

Various patterns for calender rolls have been developed. One example is the Hansen-Pennings pattern with between about 10 to 25% bond area with about 100 to 500 bonds/square inch as taught in U.S. Pat. No. 3,855,046 to Hansen and Pennings. Another common pattern is a diamond pattern with repeating and slightly offset diamonds. The particular bond pattern can be any pattern known to those skilled in the art. The bond pattern is not critical for imparting the properties to the liner or mat of the present invention.

The exact calender temperature and pressure for bonding the multilayer laminate depend on thermoplastic polymers from which the nonwoven webs and/or film material are made. Generally for multilayer nonwoven web laminates formed from polyolefins, the desired temperatures are between 150° and 350° F. (66° and 177° C.) and a pressure between 300 and 1000 pounds per linear inch. More particularly, for polypropylene, the desired temperatures are between 270° and 320° F. (132° and 160° C.) and the pressure between 400 and 800 pounds per linear inch. However, the actual temperature and pressures needed are highly dependent of the particular thermoplastic polymers used in each of the layers. The actual temperature and pressure used to bond the layers of the laminate together will be readily apparent to those skilled in the art and would depend on factors such as basis weight and line speed. Of the available method for bonding the layer of the multilayer laminate nonwoven web usable in the present invention, thermal and ultrasonic bonding are preferred due to factors such as materials cost and ease of processing.

In the practice of the present invention, it is desirable the laminate used in the wipe has sufficient hand and weight to give the user a sense that the wipe is of sufficient weight to perform the necessary cleaning. The laminate of the present invention has an overall basis weight, based on the weight of the nonwoven laminate only of from about 0.4 to 10 ounces per square yard (osy) (about 13.6 to 339 grams per square meter (gsm)), or more particularly from about 0.5 to about 6.0 osy (about 17 to about 203 gsm). Most preferably, the basis weight is between about 1.0 and 3.0 osy (about 33.9 to about 101 gsm), since this basis weight has a good balance between thickness and cushioning. Generally, the basis weights of the first and/or third layers are usually in the range of about 10 gsm to about 80 gsm, desirably between 10 gsm and 34 gsm. The basis weight of the second or intermediate layer can be in the range of about 5 gsm to about 80 gsm, desirably between about 5 gsm and 34 gsm.

Additional layers may be present in the laminate. Additional layers may be on the surface of the first layer and/or third layer away from the second or intermediate layer which can be used to improve the durability of the wet wipe or to provide a surface which can be used to scrub or scour a surface to be cleaned. Typically, the additional layers should allow liquid of the first or second layers to travel through the additional layer and onto the surface to be cleaned. This layer can be referred to as a liquid transfer. Examples of the additional layers which can be used to improve the durability of the first and/or the second layer include, for example a spunbond layer. Examples of scrubby or scouring layers include, for example, meltblown layer having a fiber diameter greater than about 30 microns.

The wipes from the laminate of the present invention can be partially or fully saturated with a cleaning fluid to provide a pre-moistened wipe, also known as a wet wipe. The wet cleaning sheets can be maintained over time in a sealable container such as, for example, within a bucket with an attachable lid, sealable plastic pouches or bags, canisters, jars, tubs, dispensers and so forth. Desirably the wet, stacked cleaning sheets are maintained in a resealable container. The use of a resealable container is particularly desirable when using volatile liquid compositions since substantial amounts of liquid can evaporate while using the first sheets thereby leaving the remaining sheets with little or no liquid. Exemplary resealable containers and dispensers include, but are not limited to, those described in U.S. Pat. No.4,171,047 to Doyle et al., U.S. Pat. No. 4,353,480 to McFadden, U.S. Pat. No. 4,778,048 to Kaspar et al., U.S. Pat. No. 4,741,944 to Jackson et al., U.S. Pat. No. 5,595,786 to McBride et al.; the entire contents of each of the aforesaid references are incorporated herein by reference. The wipers can be incorporated or oriented in the container as desired and/or folded as desired in order to improve ease of use or removal as is known in the art. Such folded configurations are well known to those skilled in the art and include c-folded, z-folded, quarter-folded configurations and the like. The stack of folded wet wipes may be placed in the interior of a container, such as a plastic tub, to provide a package of wet wipes for eventual sale to the consumer. Alternatively, the wet wipes may include a continuous strip of material which has perforations between each wipe and which may be arranged in a stack or wound into a roll for dispensing.

With regard to pre-moistened sheets, a selected amount of cleaning liquid is added to the container such that the wipes contain the desired amount of liquid. Typically, the wipes are stacked and placed in the container and the liquid subsequently added thereto. Alternatively the cleaning liquid can be added to the sheet prior to stacking and placement into the container. The sheet can subsequently be used to wipe a surface as well as act as a vehicle to deliver and apply cleaning liquids to a surface. The moistened and/or saturated wipes can be used to treat various surfaces. As used herein “treating” surfaces is used in the broad sense and includes, but is not limited to, wiping, polishing, swabbing, cleaning, washing, disinfecting, scrubbing, scouring, sanitizing, and/or applying active agents thereto. The amount and composition of the liquid added to the cleaning sheets will vary with the desired application and/or function of the wipes. As used herein the term “liquid” includes, but is not limited to, solutions, emulsions, suspensions and so forth. Thus, cleaning liquids may comprise and/or contain one or more of the following: disinfectants; antiseptics; diluents; surfactants, such as nonionic, anionic, cationic, waxes; antimicrobial agents; sterilants; sporicides; germicides; bactericides; fungicides; virucides; protozoacides; algicides; bacteriostats; fungistats; virustats; sanitizers; antibiotics; pesticides; and so forth, depending on the desired intended use. Numerous cleaning compositions and compounds are known in the art and can be used in connection with the present invention. The liquid may also contain lotions and/or medicaments. The pre-moistened wipes of the present invention can be used for baby wipes, hand wipes, face wipes, cosmetic wipes, household wipes, industrial wipes and the like.

The amount of liquid contained within each pre-moistened wipe may vary depending upon the type of material being used to provide the pre-moistened wipe, the type of liquid being used, the type of container being used to store the wet wipes, and the desired end use of the wet wipe. Generally, each pre-moistened cleaning sheet can contain from about 150 to about 900 weight percent, depending on the end use. For example, for a low lint countertop or glass wipe a saturation level of about 150 to about 650 weight percent is desirable. For a pre-saturated mop application, the saturation level is desirably from about 500 to about 900 weight percent liquid based on the dry weight of the cleaning sheet, preferably about 650 to about 800 weight percent. If the amount of liquid is less than the above-identified ranges, the cleaning sheet may be too dry and may not adequately perform. If the amount of liquid is greater than the above-identified ranges, the cleaning sheet may be oversaturated and soggy and the liquid may pool in the bottom of the container.

In the present invention, the amount of cleaning fluid added to the wipe is typically less than that added to commercially available wipes, even though the wipes of the present invention have a similar thickness to commercially available wipes. This is because the second or intermediate layer of the laminate has properties that prompt the cleaning fluid to preferentially migrate to the first and second layers. As is set forth above, the second layer holds an amount or percentage of the cleaning fluid in the wipe which is less than the percentage of the thickness of the overall wipe. Generally, the thickness of the second layer is at least 35% of the total wipe, generally at least about 50%. Likewise, the wipe of the present invention of the present invention hold less than 40% by weight/volume, when the thickness of the second layer is at least 50% of the wipe thickness. Desirably, the second or intermediate layer holds less than 30% by weight of the cleaning fluid and more desirably less than 10% by weight of the cleaning fluid and most desirably essentially none of the cleaning fluid. Minimally, the percentage of fluid retained by the second or intermediate layer is less than its percentage contribution to overall laminate thickness.

By reducing the amount of the cleaning fluid in the wipe, a significant cost savings can be realized due to the reduction in shipping costs and raw material cost. Even though the amount of the solution is reduced in the wipes, the wipes of the present invention still are perceived as being as moist as a conventional wipe. Therefore, the wipes of the present invention provide a user with the perception of having an appropriate level of bulk and wetness, comparable to that of wipes currently commercially available.

### EXAMPLES

Laminates were prepared from two layers of a conform nonwoven web material and an intermediate layer. In each of the following examples, the conform nonwoven web has a basis weight of about 18 gsm and contains approximately 65% by weight of pulp and 35% by weight of polypropylene. Each coform layer is embossed with a bear dot embossing pattern. Each conform nonwoven web had a thickness of about 0.3 mm, measure at 0.05 psi. Each of the conform nonwoven webs were placed on either side of an intermediate layer and were attached to the intermediate layer using about 2 gsm of Duro All-Purpose adhesive on each side of the intermediate layer, in the case of the foam and film, and thermally bonded in the case of the creped spunbond, shown in Table 1.

TABLE 1

| | | Approximate | |
|---|---|---|---|
| | | Basis | |
| Ex- | | weight of | Basis |
| ample | | intermediate | weight of |
| No. | Intermediate layer | layer | laminate |
| 1. | Penta L apertured film available from | 26 gsm | 68 gsm |
| | Tredegar | | |
| 2. | Closed cell polyethylene Cell Aire | 24 gsm | 64 gsm |
| | CA30 from Sealed Air Corporation | | |
| 3. | Creped spunbond 40% crepe ratio | 32 gsm | 68 gsm |

Each of the laminates were cut into samples which were about 190 mm by 190 mm in length and width. The samples were then saturated with the 6.19 grams of Natural Care Baby Wipe solution commercially used by Kimberly-Clark Corporation, Neenah, Wis. The percentage of solution add-on, the dry bulk, the wet bulk and the machine direction wet tensile strength are shown in Table 2. The liquid content of the core was measured by carefully separating the layers of the wipe and measuring the wet weight of the layer, drying the layer in a low humidity environment and measuring the dry weight of each layer. As can be seen in Table 2, the core layer of the present invention contain little, if any, of the cleaning solution even though the core layer represents a fairly large percentage of the wipes thickness.

TABLE 2

| | | | | | Core | Core |
|---|---|---|---|---|---|---|
| | | | | | thickness | liquid |
| | | | Wet | | (% based | content |
| | Dry | | Bulk, | MD | on overall | (% based |
| Ex- | Bulk, | | mm | Wet | thickness | on overall |
| ample | mm @ | % solution | @ 0.05 | Tensile, | of dry | weight of |
| No. | 0.05 psi | add-on | psi | g/inch | wipe) | wipe |
| 1. | 1.23 | 230% | 0.82 | 380 | 53% | 5% |
| 2. | 1.63 | 242% | 1.4 | 454 | 64% | 0% |
| 3. | 1.0 | 241% | 0.82 | 102 | 42% | 9% |

Each of the wipes above was compared to a 70 gsm conform containing approximately 65% by weight of pulp and 35% by weight of polypropylene, also embossed with a bear dot embossing pattern. Each comparison coform nonwoven wipe has a wet bulk thickness of about 0.66 mm, measure at 0.05 psi., and was saturated with 8.25 g of the same Natural Care Baby Wipe solution commercially used to saturate the wipes of Examples 1, 2, and 3. This resulted in a comparison wipe with a 330% liquid add-on.

Samples of the comparative saturated wipe and the wipes of Example 1, 2 and 3 were placed in sealed containers. The samples were then compared by a user panel for various attributes including wetness on the skin. Wetness on the skin was judged by the trained panel by wiping the wipe of the forearm of the panel member. Each sample of Examples 1-3 were judged to have the similar wetness on the as the control sample.

While the invention has been described in detail with respect to specific embodiments thereof, and particularly by the example described herein, it will be apparent to those skilled in the art that various alterations, modifications and other changes may be made without departing from the spirit and scope of the present invention. It is therefore intended that all such modifications, alterations and other changes be encompassed by the claims.

1. A wet wipe comprising a cleaning fluid and a laminate wherein the laminate comprises
a first layer comprising a web capable of holding and releasing the cleaning fluid comprising a thickness X;
a second layer adjacent the first layer having a lesser affinity for the cleaning fluid than the first layer, said second layer comprising a thickness Y and an overall percentage of the cleaning fluid present in the wipe Z;
wherein
$$Z \leq \frac{Y}{( X + Y )} \times 100 \% .$$

2. The wet wipe of claim 1, further comprising a third layer which comprise a web capable of holding and releasing the cleaning fluid said third layer has a thickness X′, wherein the percentage Z of the overall cleaning fluid present in the wet wipe present in the second layer is
$$Z \leq \frac{Y}{( X + {X}^{′} + Y )} \times 100 \%$$

3. The wet wipe of claim 2, wherein second layer allows the cleaning fluid to pass between the first layer and the third layer, comprises at least 35% of the thickness of the laminate and holds less than 35% by weight of the cleaning fluid present in the wipe.

4. The wet wipe of claim 3, wherein the second layer holds less that 30% by weight of the cleaning fluid in the wipe.

5. The wet wipe of claim 4, wherein the second layer holds less that 10% by weight of the cleaning fluid in the wipe.

6. The wet wipe of claim 2, wherein the first layer and third layers each comprise a nonwoven web independently selected from the group consisting of a conform nonwoven web, a meltblown nonwoven web, an airlaid nonwoven web, a bonded carded web, a hydroentangled nonwoven web or a cellulosic fiber web.

7. The wet wipe of claim 6, wherein the nonwoven material of the first layer and the second layer comprises a conform nonwoven web.

8. The wet wipe of claim 2, wherein the second layer comprises a foam, an apertured film, an apertured textured film or a hydrophobic nonwoven web.

9. The wet wipe of claim 8, wherein the second layer comprises an apertured textured film.

10. The wet wipe of claim 9, wherein the first and third layers each comprise a conform nonwoven web.

11. The wet wipe of claim 7, wherein the conform nonwoven web comprises between about 40 to about 80% by weight of pulp, and from about 20 to about 60% by weight of thermoplastic filaments.

12. The wet wipe of claim 10, wherein the conform nonwoven web comprises between about 40 to about 70% by weight of pulp, and from about 30 to about 60% by weight of thermoplastic filaments.

13. The wet wipe of claim 1, wherein the second layer comprises a closed cell foam.

14. The wet wipe of claim 2, wherein the second layer comprises a closed cell foam.

15. The wet wipe of claim 7, wherein the second layer comprises a closed cell foam.

16. The wet wipe of claim 15, wherein the second layer essentially does not contain any of the cleaning fluid in the wipe.

17. The wet wipe of claim 15, wherein the conform nonwoven web comprises between about 40 to about 80% by weight of pulp, and from about 20 to about 60% by weight of thermoplastic filaments.

18. The wet wipe of claim 2, wherein the first and third layers each independently have a basis weight of about 10 gsm to about 34 gsm, and the third layer has a basis weight of about 5 gsm to about 34 gsm.

19. The wet wipe of claim 7, wherein the first and third layers each independently have a basis weight of about 10 gsm to about 34 gsm, and the third layer has a basis weight of about 5 gsm to about 34 gsm.
